(19) United States
(12) Patent Application Publication
(10) Pub. No.: US 2009/0006255 A1
(43) Pub. Date: Jan. 1, 2009

(54) Method of Authentication of the Items Put Into Circulation

(76) Inventors: Georgy Vasilejvich Bychkov, Moscow (RU); Sergey Matveevich Chak, Moskva (RU)

Correspondence Address: YOUNG & THOMPSON, 209 Madison Street, Suite 500, ALEXANDRIA, VA, 22314, US

(21) Appl. No.: 12/160,603

(22) PCT Filed: Nov. 29, 2006
(86) PCT No.: PCT/RU06/00638

§ 371 Date: Jul. 11, 2008

(51) Int. Cl. H04L 9/00

(52) U.S. Cl. 705/50

(57) ABSTRACT

An efficient and universal anti-counterfeit protection of commercial products allows consumers, wholesalers and interested regulatory authorities to rapidly and reliably check the authenticity of products put into circulation. The authentication system administrator manufactures and provides the manufacturer of an authentic product with the requested quantity of authentication marks. Each authentication mark includes a set of symbols. One part of this set is open for reading and is the identification combination. The authentication marks are attached to the products such that reading the identification combination is impossible without causing permanent damage to the protective media. Then administrator has a description of the items bearing such authentication marks, and checks the identification combination contained in the request against the identification combination whose serial number in the authentication database coincides with the serial number of the item.

### FIELD OF THE INVENTION

This invention relates to the manufacture and sale of commercial products of any type and can be used for the anti-counterfeit protection of items manufactured under a specific trademark, including medicines, perfumery and cosmetics, as well as substances and raw materials for their production; cigarettes and tobaccos, foods, including bottled alcoholic beverages, parts and units of machinery, mechanisms and electronic devices, electronic media, printed products as well as other products having common attributes and put into circulation on a large scale.

Currently, product manufacturers incur large material and moral losses due to the counterfeiting and unauthorized production of various items under the trademarks owned by the said manufacturers. One method of anti-counterfeit protection can be to authenticate commercially released products, this procedure including the confirmation of the manufacturer that actually puts into circulation the item being authenticated.

### PRIOR ART

Known is a method to identify counterfeits (RU 2202127 C2, published 2003 Apr. 10) wherein the products are marked with a random internal structured ornament applied to the media material as an authentication mark.

A disadvantage of this method is that the said authentication mark can be counterfeited. It is suggested to produce the random internal ornament for the authentication mark in the form of the inherent internal structure of natural materials such as wood, stone, leaves, etc. However, the process of copying and further counterfeiting the authentication mark based on some random ornament does not present a technical problem for advanced techniques of copying visually perceptible structures using digital electronic devices such as scanners and digital still cameras that are commercially available to a wide range of customers, including counterfeiters.

Known also is a method of anti-counterfeit protection of commercial products (RU 2225641 C2, published 2004.03.10) wherein the products are marked by applying an identification combination by printing or otherwise, when the identification combination is protected from visual perception and individual identification numbers are stored in the database.

A disadvantage of this method is that when authenticating a product an identification number database administrator has to check the identification number of each specific product against the entries of the said database consisting of an array of random numbers. If the number of entries in the database is large, the identification number search procedure requires the use of highly efficient and hence expensive computers and takes a long time. The known invention implies limiting the digit capacity of the randomly generated part of the identification combination to six digits. However, in commercial production there can emerge a situation when a better part of random combinations for the authentication of products belonging to the same batch is exhausted within one working shift as long as hundreds of thousands of such items are produced during this shift, and the reliability of this protection method will then be reduced, as a random combination reproduced by counterfeiters for marking a non-non-authentic item may probably coincide with a combination already existing in the administrator's database. Therefore the applications of the known invention are limited to small batch manufacture of products requiring authentication where the need for anti-counterfeit protection is much smaller than in the case of large-scale manufacture. Another disadvantage of this invention is that it does not imply repeated authentication of the same item and that the conclusion as to the authenticity of a item is solely charged upon the database administrator, whereas the product authenticating person has no information on the product being authenticated that could be used for an independent judgment as to the authenticity of the item in question.

The object of the invention disclosed herein is to provide an efficient and universal counterfeit protection of commercial products and to allow consumers, wholesalers and interested regulatory authorities to rapidly and reliably check the authenticity of products and other items put into circulation.

### DISCLOSURE OF THE INVENTION

Below is a description of the method according to the invention disclosed herein whereby the said object and the following technical results are achieved:
enhanced protection of the manufacturers from unauthorized manufacture of products under their trademarks or under original product names by third parties;
increased efficiency of the method due to the possibility of rapidly searching the information on the product being authenticated in databases containing large amounts of information, the possibility to repeatedly authenticate the same item and the possibility to track the history of the item circulation;
simplification of the method and reduction of its cost due to the technically simplified procedures of both marking the products put into circulation and the authentication procedure.

According to this method of authenticating items put into circulation, the authentication system administrator generates and provides the manufacturer of an authentic item with the specified quantity of authentication marks upon the manufacturer's request. Each authentication mark carries a set of symbols. One part of this set is open for reading and is the serial number of the authentication mark. The other part of the set is covered with a protective media not allowing its visual perception and is the identification combination.

Following this, the manufacturer marks the items put into circulation with the authentication marks provided as above. The authentication marks are attached to the products in such a manner that reading the identification combination is impossible without causing permanent damage to the protective media. Then the manufacturer provides the authentication system administrator with a description of the items bearing such authentication marks.

A person participating in the circulation of items bearing the authentication mark and interested in identifying this item's authenticity removes the protective media after checking its integrity, reads the identification combination and forwards a request to the authentication system administrator containing the serial number and the identification combination of the item's authentication mark via any communication means available.

The authentication system administrator compares the identification combination specified in the request against the identification combination whose serial number in the authentication database coincides with the serial number specified in the request, and if the respective identification combinations coincide, forwards to the person performing the item authentication the description of the item that is contained in the database and related to the authentication mark in question.

The person performing authentication concludes as to the authenticity of the item if the item description in this person's possession coincides with the product description received from the authentication system administrator.

In a specific embodiment of the method, the identification combination is a randomly generated sequence of digits and/or characters and/or graphical symbols.

In specific embodiments of the method, the identification combination further includes a duplication of the authentication mark serial number.

Also, in specific embodiments of the method, the manufacturer of items put into circulation marks each item with one or more authentication marks by applying the authentication marks directly to the product and/or to the package of an individual item and/or to the common package of multiple individual items.

Also, in specific embodiments of the method, the identification combination of the authentication mark is protected from visual perception by placing it inside the product package so its reading is impossible without violating the integrity of the product package.

For this case, in a specific embodiment of the method, the item description provided to the authentication system administrator includes product description, manufacturer name and/or other description information characterizing the items of their properties and/or information on persons certifying the properties of the authentication mark bearing items.

Also, in a specific embodiment of the method, the product authenticating person provides the authentication system administrator with information comprising that person's personal data for generating the circulation history of the item being authenticated.

Also, in a specific embodiment of the method, the authentication system administrator provides the product authenticating person with information on prior authentications of that item.

### EMBODIMENTS OF THE INVENTION

The method of authenticating items put into circulation is implemented as follows.

The persons participating in the implementation of the method are as follows:
authentic item (product) manufacturers;
persons participating in the circulation of the items, interested in authenticating the items and performing the authentication procedure;
the authentication system administrator.

Within the method of authenticating items put into circulation, the authentication system administrator, upon request from the authentic item manufacturer, produces the requested quantity of authentication marks and supplies the item manufacturer with the said authentication marks. Each authentication mark includes a set of symbols. One part of this set is open for reading (overt) and is the serial number of the authentication mark. The other part of the set is covered with a protective media not allowing its visual perception and includes the identification combination in the form of a randomly generated sequence of digits and/or characters and/or graphical symbols, wherein the combination of random symbols covered by the protective media can be further supplemented with a duplication of the authentication mark serial number.

The number of digits in the authentication mark is chosen to minimize the possibility of its occasional reproduction by counterfeiters attempting to reproduce the authentication mark on non-authentic items. The said identification combination comprises at least eight digits and is assigned to a serial number that is unique for each authentication mark, thus minimizing the probability of occasional reproduction of this combination by counterfeiters, as the number of possible variants to be tried when attempting to find the identification combination assigned to one authentication mark is 100 million.

The manufacturer marks the items put into circulation with the authentication marks provided by the authentication system administrator. The items are marked by applying one or more authentication marks to the product and/or to the package of an individual item and/or to the common package of multiple individual items in such a manner that reading the identification combination is impossible without causing permanent damage to the protective media. Following this the manufacturer provides the authentication system administrator with a description of the items bearing such authentication marks, wherein the item description provided to the authentication system administrator includes product description, manufacturer name and/or other description information characterizing the items of their properties and/or information on persons certifying the properties of the authentication mark bearing items.

To authenticate the authentication mark bearing item in course of its circulation, the person willing to authenticate the said item and carrying out the authentication procedure checks the integrity of the protective media covering the identification combination, removes the protective media, reads the identification combination and forwards a request to the authentication system administrator containing the serial number of the authentication mark and the identification combination of the item's authentication mark via any communication means available.

Reading the symbols under the protective media is impossible without causing permanent damage to the protective media or to the package of the item itself. For this purpose, the protective media of the identification combination can be made in the form of a removable paper strip, scratched metallized, plastic or other coating applied by sputtering, printing or any other method. Moreover, the identification combination can be hidden inside a folded label made from paper or other material that should be torn and/or unfolded to read the identification combination. The identification combination can be hidden inside the product package in such a manner that reading the identification combination is impossible without causing permanent damage to the product package.

The authentication system administrator checks the identification combination contained in the request against the identification combination whose serial number in the authentication database coincides with the serial number of the item. If the respective identification combinations coincide, the authentication system administrator concludes that the authentication mark being analyzed has actually been generated by the authentication system administrator and the authentication procedure can be continued. Following this the authentication system administrator forwards to the person performing the item authentication procedure the description of the item that is available in the database as related to the authentication mark provided by that person, this description including the product description, manufacturer name, other item manufacturer information if available as well as information on prior authentications of that item. The conclusion as to the authenticity of the item is made by the product authenticating person if the description related to the specific authentication mark received from the authentication system administrator coincides with the information on the product being authenticated available to the authenticating person.

Under this invention, product authentication is performed through searching the authentication mark database for serial numbers of the authentication marks. Search in the database of identification combinations that are random combinations of various symbols is not provided for by the item authentication technology. Identification combinations are only used to confirm the legitimacy of processing the information related to the authentication mark serial number forwarded within the request for item authentication. These particular features of the item authentication method allow using simple software and hardware for data processing and minimize the data sampling time. This provides for fast data search on the product being authenticated in a database containing large amounts of information.

When communicating with the authentication system administrator, the product authenticating person may additionally provide the authentication system administrator with their personal data. This data will be included in the circulation history of the product being authenticated and can be used, for example, to confirm the legitimacy of the product circulation as another certificate of its authenticity.

The invention includes provision for marking the item with more than one authentication marks. As the item is circulating from one person to another, each person participating in item circulation can authenticate the product by using one of the authentication marks with yet uncovered identification combination. This allows for multiple authentications of the same item.

The invention includes provision for communicating the description of the authentication mark bearing item from the product manufacturer to the authentication system administrator. This information includes product name, manufacturer name and, if the manufacturer so wishes and the authentication system administrator approves, typical and/or descriptive data on the authentication mark bearing items characterizing the items of their properties and/or information on persons certifying the properties of the authentication mark bearing item. This information is assigned by the manufacturer to the serial number of the authentication mark applied to the item. This data cannot be used to counterfeit the authentication mark as it contains, along with the authentication mark serial number, the identification combination associated with the authentication mark in the authentication system administrator database. This allows communicating authentication mark information from the manufacturer to the authentication system administrator via open communication channels.

The invention includes provision for communicating information on product authenticating persons to the authentication system administrator. This information is provided in course of authentication procedure and is entered in the authentication mark database. At a repeated request for authentication through the authentication mark that has already been used for the item authentication procedure, the person requesting this repeated authentication is provided with data on the first authentication related to this authentication mark, including data on the person who was the first to carry out the authentication procedure through this authentication mark, if such information is available in the database. This allows tracking the history of the item circulation, i.e. its transfer from one person participating in the item circulation to another. This history allows tracking the legitimacy of product transfer from one person to another and thus getting an additional indirect confirmation of product authenticity.

The trustworthiness of authentication using the method suggested herein is provided for by the lack of any economic reason to counterfeit and duplicate authentication marks on non-authentic products. To know the true identification combinations the counterfeiters will have to purchase authentic products marked with authentication marks containing true identification combinations in the same quantity as the quantity of products they plan to counterfeit. After removing the protective media on the identification combinations for their reading, these authentic products can no longer be sold because consumers will distinct these products as potentially non-authentic judging from the appearance of the uncovered identification combinations. If a counterfeiter uses only one true identification number for the entire batch of counterfeit products, these products will be identified as non-authentic beginning from the second authentication request for the same identification combination. A product will also be identified as non-authentic if marked with an authentication mark containing an identification combination chosen by the counterfeiter at random. Thus, release of non-authentic products into circulation will be greatly complicated due to the counterfeiter understanding the threat of discovering this event and further prosecution as provisioned by the applicable legislation for persons participating in the manufacture and circulation of such products. This provides for a high degree of manufacturer protection from unauthorized production of items by third parties under the trademarks owned by the said manufacturers.

The invention disclosed herein allows counteracting product counterfeiters very efficiently and without incurring high implementation costs.

1. Method of authenticating items put into circulation wherein the authentication system administrator, at the request of an authentic product manufacturer, generates and provides the item manufacturer with the specified quantity of authentication marks each of which contains a set of symbols one part of which is open for reading (overt) and is the serial number of the authentication mark, and the other part of which is covered with a protective media a not allowing its visual perception (covert) and is the identification combination, following which the manufacturer marks items put into circulation with the authentication marks provided by the authentication system administrator by attaching authentication marks to the products in such a manner that reading the identification combination is impossible without causing permanent damage to the protective media, and provides the authentication system administrator with a description of the items bearing such authentication marks, a person participating in the circulation of authentication mark bearing items and interested in its authentication removes the protective media after checking its integrity, reads the identification combination and forwards a request to the authentication system administrator containing the serial number and the identification combination of the item authentication mark via any communication means available, the authentication system administrator checks the identification combination contained in the request against the identification combination whose serial number in the authentication database coincides with the serial number of the item and, if the respective identification combinations coincide, forwards to the person performing the item authentication procedure the description of the item that is available in the database as related to the authentication mark provided by that person, and the person performing authentication concludes as to the authenticity of the item if the product description in this person's possession coincides with the product description received from the authentication system authentication system administrator.

2. Method according to claim 1, wherein the said identification combination is a randomly generated sequence of digits and/or characters and/or graphical symbols.

3. Method according to claim 1, wherein the said identification combination further includes a duplication of the authentication mark serial number.

4. Method according to claim 1, wherein the said manufacturer of items put into circulation marks each item with one or more authentication marks by applying the authentication marks directly to the product and/or to the package of an individual item and/or to the common package of multiple individual items.

5. Method according to claim 1, wherein the said identification combination of the authentication mark is protected from vista perception by placing it inside the product package so its reading is impossible without violating the integrity of the product package.

6. Method according to claim 1, wherein the said item description provided to the authentication system administrator includes product name, manufacturer name, and/or other description information characterizing the items of their properties, and/or information on persons certifying the properties of the authentication mark bearing items.

7. Method according to claim 1, wherein the said product authenticating person provides the authentication system administrator with information comprising that person's personal data for generating the history of the item being authenticated.

8. Method according to claim 1, wherein the said authentication system administrator provides the product authenticating person with information on prior authentications of that item.

9. Method according to claim 7, wherein the said authentication system administrator provides the product authenticating person with information on prior authentications of that item.
